(19) United States
(12) Patent Application Publication
(10) Pub. No.: US 2015/0073111 A1
(43) Pub. Date: Mar. 12, 2015

(54) FLUOROELASTOMERS HAVING SECONDARY CYANO GROUP CURE SITES

(71) Applicant: E I DU PONT DE NEMOURS AND COMPANY, Wilmington, DE (US)

(72) Inventors: Ming Hong Hung, Wilmington, DE (US); Phan Linh Tang, West Chester, PA (US)

(21) Appl. No.: 14/475,868

(22) Filed: Sep. 3, 2014

Related U.S. Application Data
(60) Provisional application No. 61/875,835, filed on Sep. 10, 2013.

(51) Int. Cl. C08F 214/22

(52) U.S. Cl. CPC C08F 214/222
USPC 526/247

(57) ABSTRACT

This invention pertains to fluoroelastomers comprising copolymerized units of vinylidene fluoride, at least one other fluoroolefin and a cure site monomer having a secondary cyano group, as well as cured fluoroelastomer compositions made therefrom. It has been surprisingly discovered that fluoroelastomers that contain a cure site monomer having a secondary cyano group contain much less gel than do similar fluoroelastomers that employ a cure site monomer having a primary cyano group. Furthermore cured (i.e. crosslinked) fluoroelastomer compositions that contain a fluoroelastomer having secondary cyano groups have a better (i.e. lower) compression set than do similar cured fluoroelastomer compositions that contain a fluoroelastomer having primary cyano groups.

### FIELD OF THE INVENTION

This invention pertains to fluoroelastomers comprising copolymerized units of vinylidene fluoride, at least one other fluoroolefin and a cure site monomer having a secondary cyano group.

### BACKGROUND OF THE INVENTION

Fluoroelastomers having excellent heat resistance, oil resistance, and chemical resistance have been used widely for sealing materials, containers and hoses. Examples of fluoroelastomers include copolymers comprising units of vinylidene fluoride (VF₂) and units of at least one other copolymerizable fluorine-containing monomer such as hexafluoropropylene (HFP), tetrafluoroethylene (TFE), chlorotrifluoroethylene (CTFE), vinyl fluoride (VF), and a fluorovinyl ether such as a perfluoro(alkyl vinyl ether) (PAVE). Specific examples of PAVE include perfluoro(methyl vinyl ether), perfluoro(ethyl vinyl ether) and perfluoro(propyl vinyl ether).

In order to fully develop physical properties such as tensile strength, elongation, and compression set, elastomers must be cured, i.e. vulcanized or crosslinked. In the case of fluoroelastomers, this is generally accomplished by mixing uncured polymer (i.e. fluoroelastomer gum) with a polyfunctional curing agent and heating the resultant mixture, thereby promoting chemical reaction of the curing agent with active sites along the polymer backbone or side chains. Interchain linkages produced as a result of these chemical reactions cause formation of a crosslinked polymer composition having a three-dimensional network structure. Commonly employed curing agents for fluoroelastomers include difunctional nucleophilic reactants such as polyhydroxy compounds or diamines and also free radical curing agents such as the combination of an organic peroxide with a multifunctional coagent such as triallylisocyanurate.

Perfluoroelastomers comprising copolymers of tetrafluoroethylene, perfluoro(methyl vinyl ether) and a cyano group-containing cure site monomer are well known in the art. See for example U.S. Pat. Nos. 4,282,092; 4,525,539; 4,983,680; 6,281,296 B1 and 6,638,999 B2. These perfluoroelastomers offer some advantages (e.g. better heat and chemical resistance) over fluoroelastomers. The advantages are due to both the differences in the polymer composition and to the different crosslinking chemistry made possible by the cyano cure sites.

U.S. 2011/0151164 A1 discloses curable fluoroelastomers that contain cyano cure sites. However, it is difficult to polymerize electron-withdrawing cyano containing cure site monomers with electron rich fluoroelastomer polymer chains that contain vinylidene fluoride. Typically an undesirable gel forms.

It would be desirable to have fluoroelastomers containing cyano cure sites with no gel.

### SUMMARY OF THE INVENTION

It has been surprisingly discovered that fluoroelastomers that contain a cure site monomer having a secondary cyano group contain much less gel than do similar fluoroelastomers that employ a cure site monomer having a primary cyano group. Furthermore cured (i.e. crosslinked) fluoroelastomer compositions that contain a fluoroelastomer having secondary cyano groups have a better (i.e. lower) compression set than do similar cured fluoroelastomer compositions that contain a fluoroelastomer having primary cyano groups.

One aspect of the present invention provides a fluoroelastomer comprising copolymerized units of:
A) vinylidene fluoride;
B) at least one fluoroolefin different from said vinylidene fluoride; and
C) a fluoroolefin having a secondary cyano group.

Another aspect of the invention is a cured fluoroelastomer composition comprising a crosslinked fluoroelastomer comprising copolymerized units of i) vinylidene fluoride; ii) at least one fluoroolefin different from said vinylidene fluoride; and iii) a fluoroolefin having a secondary cyano group.

### DETAILED DESCRIPTION OF THE INVENTION

The present invention is directed to a fluoroelastomer that contains a plurality of secondary cyano group cure sites. By “fluoroelastomer” is meant an amorphous elastomeric fluoropolymer. The fluoropolymer contains at least 53 percent by weight fluorine, preferably 63 to 72 wt. % fluorine. Fluoroelastomers of this invention contain between 25 and 70 weight percent, based on the weight of the fluoroelastomer, of copolymerized units of vinylidene fluoride (VF₂). The remaining units in the fluoroelastomer copolymers are comprised of at least one additional fluoroolefin, different from said VF₂, and a cure site monomer having a secondary cyano group. Optionally, the fluoroelastomers of the invention may further comprise copolymerized units of a hydrocarbon olefin such as propylene or ethylene.

Fluorine-containing olefins copolymerizable with the VF₂ include, but are not limited to hexafluoropropylene (HFP), tetrafluoroethylene (TFE), 1,2,3,3,3-pentafluoropropene (1-HPFP), chlorotrifluoroethylene (CTFE), vinyl fluoride and also fluorine-containing vinyl ethers such as, but not limited to perfluoro(alkyl vinyl) ethers. Perfluoro(alkyl vinyl) ethers (PAVE) suitable for use as monomers include those of the formula

CF₂=CFO(R_{f′}O)ₙ(R_{f″}O)ₘR_{f} (I)

where R_{f′} and R_{f′} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂=CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl) ether (PMVE) and perfluoro(propyl vinyl) ether (PPVE). Other useful monomers include compounds of the formula

CF₂=CFO[(CF₂)ₘCF₂CFZO]ₙRf (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluoro(alkyl vinyl) ether monomers include those of the formula

CF₂=CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl) ethers include

CF₂=CFOCF₂CF(CF₃)O(CF₂O)ₘCₙF₂ₙ₊₁ (V)

where n=1-5, m=1-3, and where, preferably, n=1.

Cure site monomers that are suitable for use in this invention are fluoroolefins having a secondary nitrile group. Specific examples include, but are not limited to CF₂=CF—O—(CF₂)₃-OCF(CN)CF₃ and CH₂=CH-(Rf)ₙ-CF(CN)CF₃ wherein Rf is a perfluoroalkylene group that may contain one or more oxygen atoms and n is an integer from 1 to 4.

Units of secondary cyano group-containing cure site monomer are typically present at a level of 0.05-10 wt. % (based on the total weight of fluoroelastomer), preferably 0.05-5 wt. % and most preferably between 0.05 and 3 wt. %.

Specific fluoroelastomers which may be employed in this invention include, but are not limited to those having at least 53 wt. % fluorine and comprising, in addition to copolymerized units of a cure site monomer having a secondary cyano group, copolymerized units of i) vinylidene fluoride and hexafluoropropylene; ii) vinylidene fluoride, hexafluoropropylene and tetrafluoroethylene, iii) vinylidene fluoride and perfluoro(methyl vinyl) ether, iv) vinylidene fluoride perfluoro(methyl vinyl) ether and tetrafluoroethylene and v) vinylidene fluoride, tetrafluoroethylene and propylene.

The fluoroelastomers of this invention are curable with the well known crosslinking agents typically employed with perfluoroelastomers having cyano cure sites. These crosslinking agents (or curatives) include, but are not limited to bis(aminophenols) such as diaminobisphenol AF, ammonia generators such as urea, and free radical systems such as the combination of an organic peroxide with a multifunctional coagent such as triallylisocyanurate.

Curable compositions are made by combining fluoroelastomer, curative and any other conventional rubber ingredients such as fillers, colorants, process aids, etc. in a mixer. The curable composition is then shaped via a process such as extrusion or compression molding. The shaped, curable composition is typically cured by heating. For optimum results, the curable composition may optionally be post cured in an oven for several hours.

The fluoroelastomers of this invention may be employed in seals, gaskets, tubing, multilayer hoses, etc.

### EXAMPLES

### Test Methods

Fluoroelastomer composition (mole percent) was determined by ¹H and ¹⁹F NMR in a solvent or at enhanced temperature.

Glass transition temperature (Tg) was determined by differential scanning calorimetry (DSC).

Compression set was determined by ASTM D395-89, 15% compression for 168 hours at 200° C.

The invention is further illustrated by, but is not limited to the following examples.

### Example 1

The polymer was prepared by a semi-batch emulsion polymerization process, carried out at 60° C. in a well-stirred reaction vessel. A solution of 1243.3 g deionized, deoxygenated water, 5.3 g Zonyl® 1033D and 1.39 sodium phosphate dibasic heptahydrate was charged to a 2-liter reactor. The solution was heated to 60° C. After removal of trace oxygen, the reactor was pressurized to 300 psig (2.1 MPa) with a monomer mixture of 4 wt % vinylidene fluoride (VF2), 86 wt % hexafluoropropylene (HFP), and 10 wt % tetrafluoroethylene (TFE). A 30 ml sample of a 10 wt. % ammonium persulfate and 10 wt. % sodium phosphate dibasic heptahydrate solution was then added. As the reactor pressure dropped, a monomer mixture of 37.4 wt % VF2, 38.5 wt % HFP and 24.1 wt % TFE was supplied to the reactor to maintain a pressure of 300 psig throughout the polymerization. Liquid cure-site monomer CF₂=CF—O—(CF₂)₃-OCF(CN)CF₃ (iso-8CNVE) was fed in ratio to monomer feed during polymerization at a rate of 1 ml per 20 grams of monomer feed. Additional initiator solution was added to maintain polymerization rate. After a total of 417 g incremental monomer had been fed, monomer addition was discontinued and the reactor was purged of residual monomer. The total reaction time was 2.9 hours. The resulting fluoroelastomer latex had a solids content of 25.3 wt % and a pH of 5.2. The fluoroelastomer latex was coagulated with K-alum solution, washed with deionized water, and dried. The fluoroelastomer contained 23.5 mol % TFE, 52.0 mol % VF2, 24.2 mol % HFP and 0.43 mol % iso-8-CNVE. Tg was −8.4° C.

### Example 2

The polymer was prepared by a semi-batch emulsion polymerization process, carried out at 60° C. in a well-stirred reaction vessel. A solution of 1243.3 g deionized, deoxygenated water, 5.3 g Zonyl® 1033D and 1.39 sodium phosphate dibasic heptahydrate was charged to a 2-liter reactor. The solution was heated to 60° C. After removal of trace oxygen, the reactor was pressurized to 200 psig (1.4 MPa) with a monomer mixture of 43 wt % vinylidene fluoride (VF2), 54 wt % perfluoromethyl vinyl ether (PMVE), and 3 wt % tetrafluoroethylene (TFE). A 30 ml sample of a 10 wt % ammonium persulfate and 10 wt % sodium phosphate dibasic heptahydrate solution was then added. As the reactor pressure dropped, a monomer mixture of 55 wt % VF2, 35 wt % PMVE and 10 wt % TFE was supplied to the reactor to maintain a pressure of 200 psig throughout the polymerization. Liquid cure-site monomer iso-8CNVE was fed in ratio to monomer feed during polymerization at a rate of 1 ml per 20 grams of monomer feed. Additional initiator solution was added to maintain polymerization rate. After a total of 417 g incremental monomer had been fed, monomer addition was discontinued and the reactor was purged of residual monomer. The total reaction time was 2.9 hours. The resulting fluoroelastomer latex had a solids content of 31.8 wt. % and a pH of 6.2. The fluoroelastomer latex was coagulated with K-alum solution, washed with deionized water, and dried. The fluoroelastomer contained 20.2 mol % TFE, 54.9 mol % VF2, 22.6 mol % PMVE and 2.34 mol % iso-8-CNVE. Tg was −31.3° C.

### Comparative Example A

The polymer was prepared the same way as that of Example 1 except that CF₂=CF—O—CF₂CF(CF₃)-OCF₂CF₂CN (8CNVE) was used instead of iso-8CNVE as the cure site monomer. The total reaction time was 11.5 hours. The resulting fluoroelastomer latex had a solids content of 23.8 wt. % and a pH of 5.7. The fluoroelastomer contained 26.1 mol % TFE, 47.8 mol % VF2, 25.4 mol % HFP and 0.69 mol % 8-CNVE.

### Comparative Example B

The polymer was prepared the same way as the polymer of Example 2 except 8CNVE was used instead of iso-8CNVE. The total reaction time was 16.3 hours. The resulting fluoroelastomer latex had a solids content of 23.1 wt. % and a pH of 4.7. The fluoroelastomer contained 19.5 mol % TFE, 55.6 mol % VF2, 22.4 mol % PMVE and 2.37 mol % 8-CNVE.

### Example 3

The polymer was prepared the same way as the polymer of Example 1 except iso-8CNVE was fed in ratio to monomer feed during polymerization at a rate of 1.5 ml per 20 grams of monomer feed. The total reaction time was 3.5 hours. The resulting fluoroelastomer latex had a solids content of 25.3 wt. % and a pH of 5.6. The fluoroelastomer contained 26.4 mol % TFE, 49.6 mol % VF2, 23.5 mol % HFP and 0.50 mol % iso-8-CNVE. Tg was −9.6° C.

### Example 4

The polymer was prepared the same way as that of Example 3 except a 20 ml sample of a 10 wt. % ammonium persulfate and 10 wt. % sodium phosphate dibasic heptahydrate solution was added to initiate the polymerization. The total reaction time was 5.4 hours. The resulting fluoroelastomer latex had a solids content of 24.6 wt. % and a pH of 2. The fluoroelastomer contained 27.0 mol % TFE, 49.6 mol % VF2, 22.3 mol % HFP and 1.14 mol % iso-8-CNVE. Tg was −11.7° C.

### Example 5

The polymer was prepared the same way as that of Example 2 except iso-8CNVE was fed in ratio to monomer feed during polymerization at a rate of 1.5 ml per 20 grams of monomer fed. The total reaction time was 5.9 hours. The resulting fluoroelastomer latex had a solids content of 25.3 wt. % and a pH of 6.2. The fluoroelastomer contained 19.4 mol % TFE, 55.6 mol % VF2, 22.2 mol % PMVE and 2.77 mol % iso-8-CNVE. Tg was −31.6° C.

### Comparative Example C

A control polymer was prepared the same way as that of Comparative Example A. The total reaction time was 12.5 hours. The resulting fluoroelastomer latex had a solids content of 22.8 wt. % and a pH of 5.6. The fluoroelastomer contained 28.4 mol % TFE, 45.8 mol % VF2, 25.2 mol % HFP and 0.60 mol % 8-CNVE. The Tg was −7.5° C.

### Example 6

Curable compositions were made by compounding fluoroelastomer, carbon black MT N990, ZnO, Luperco® X101 organic peroxide (available from Aldrich) and Daik™ 7 triallylisocyanurate coagent (available from Aldrich) on a 2-roll rubber mill. Formulations are shown in Table I. A peroxide curable fluoroelastomer of the prior art, Viton® GF (available from DuPont) comprising copolymerized units of VF2, HFP, TFE and a bromine-containing cure site monomer was used as a control.

O-rings were then made by compression molding at 177° C. to 199° C. for 15-24 minutes, followed by a post cure at 232° C. for 16 hours. Compression set values are also shown in Table I.

There was too much gel in the polymer from Comparative Example B to mold o-rings, so compression set could not be determined (ND).

The data in Table I confirmed that the fluoroelastomers of the invention having secondary cyano cure sites (i.e. fluoroelastomer from Examples 1 and 2) had better (i.e. lower) compression set results than did comparative fluoroelastomers having primary nitrile cure sites (fluoroelastomers from Comparative Examples A & B) and also better than a similar fluoroelastomer having Br cure sites (Viton® GF).

TABLE I

| | Comp. | | | Comp. | Comp. |
|---|---|---|---|---|---|
| | Sample | Sample | | Sample | Sample |
| Formulation (phr¹) | A | 1 | Sample 2 | C | D |
| Viton ® GF | 100 | 0 | 0 | 0 | 0 |
| Ex. 1 Polymer | 0 | 100 | 0 | 0 | 0 |
| Ex. 2 Polymer | 0 | 0 | 100 | 0 | 0 |
| Comp. Ex. A Polymer | 0 | 0 | 0 | 100 | 0 |
| Comp. Ex. B Polymer | 0 | 0 | 0 | 0 | 100 |
| Carbon Black | 30 | 30 | 30 | 30 | 30 |
| ZnO | 3.0 | 3.0 | 3.0 | 3.0 | 3.0 |
| Organic Peroxide | 3.0 | 3.0 | 3.0 | 3.0 | 3.0 |
| Coagent | 3.0 | 3.0 | 3.0 | 3.0 | 3.0 |
| Compression Set, % | 78.6 | 60.3 | 39.7 | 73.0 | ND |

¹parts by weight per hundred parts rubber (i.e. elastomer)

### Example 7

Curable compositions were made by compounding fluoroelastomer, carbon black MT N990, urea, diaminobisphenol AF (DABPAF) (available from Central Glass, Japan) on a 2-roll rubber mill. Formulations are shown in Table II.

O-rings were then made by compression molding at 177° to 199° C. for 15-24 minutes, followed by a post cure at 232° C. for 16 hours. Compression set values are also shown in Table II.

There was too much gel in the polymer from Comparative Example B to mold o-rings.

In this experiment set, the fluoroelastomers of the invention (i.e. polymers from Examples 1 and 2) that contain secondary cyano cure sites and comparative fluoroelastomers (i.e. polymers from Comparative Examples A & B) that contain primary cyano cure sites were evaluated with a urea/DABPAF curing system. The results again gave very satisfactory compression set values for the compositions of the invention (Samples 3 and 4) vs. the compression set of prior art compositions (Comparative Samples E & F).

TABLE II

| | | | Comp. | Comp. |
|---|---|---|---|---|
| Formulation (phr) | Sample 3 | Sample 4 | Sample E | Sample F |
| Ex. 1 Polymer | 100 | 0 | 0 | 0 |
| Ex. 2 Polymer | 0 | 100 | 0 | 0 |
| Comp. Ex. A Polymer | 0 | 0 | 100 | 0 |
| Comp. Ex. B Polymer | 0 | 0 | 0 | 100 |
| Carbon Black | 30 | 30 | 30 | 30 |
| Urea | 0.15 | 0.15 | 0.15 | 0.15 |
| DABPAF | 2.0 | 2.0 | 2.0 | 2.0 |
| Compression Set, % | 36.2 | 19.4 | 61.3 | ND |

What is claimed is:

1. A fluoroelastomer comprising copolymerized units of:
A) vinylidene fluoride;
B) at least one fluoroolefin different from said vinylidene fluoride; and
C) a fluoroolefin having a secondary cyano group.

2. A cured fluoroelastomer composition comprising a crosslinked fluoroelastomer comprising copolymerized units of i) vinylidene fluoride; ii) at least one fluoroolefin different from said vinylidene fluoride; and iii) a fluoroolefin having a secondary cyano group.
